(19) United States
(12) Patent Application Publication
(10) Pub. No.: US 2014/0084673 A1
(43) Pub. Date: Mar. 27, 2014

(54) Brake Control Apparatus

(71) Applicant: Hitachi Automotive Systems, Ltd., Hitachinaka-shi (JP)

(72) Inventor: Atsushi MATSUOKA, Hadano-shi (JP)

(73) Assignee: Hitachi Automotive Systems, Ltd., Hitachinaka-shi (JP)

(21) Appl. No.: 14/022,526

(22) Filed: Sep. 10, 2013

(30) Foreign Application Priority Data
Sep. 24, 2012 (JP) 2012-209130

(51) Int. Cl. B60T 13/58; B60L 7/26; B60T 13/14

(52) U.S. Cl. CPC B60T 13/586; B60T 13/142; B60L 7/26
USPC 303/3; 303/6.01

(57) ABSTRACT

A brake control apparatus includes: a fluid storing section for storing a quantity of brake fluid that is flown out of a master cylinder by driver's braking operation; pressure-increasing control valves each of which is disposed between the master cylinder and a corresponding one of wheel cylinders; a master cylinder pressure reduction control valve disposed in a fluid passage connected between the master cylinder and the fluid storing section. A hydraulic pressure control section is configured to perform a control operation when a braking force is being controlled with a regenerative braking system, wherein the control operation includes: controlling at least one of the pressure-increasing control valves toward closed state; controlling the master cylinder pressure reduction control valve toward open state; and allowing the quantity of brake fluid to flow into the fluid storing section.

### BACKGROUND OF THE INVENTION

The present invention relates to brake control apparatuses.

JP 2007-500104 A (Japanese translation of PCT international application) corresponding to US 2007/0296264 A1 discloses a brake control apparatus which is configured to discharge brake fluid into an accumulator by opening a valve (SG valve 16 in this document), and thereby suppress a braking force generated by a frictional braking system, when a regenerative braking system is operating.

### SUMMARY OF THE INVENTION

The brake control apparatus described above has a disadvantage that the amount of regeneration produced by the regenerative braking system may be adversely affected by a configuration that the frictional braking system (wheel cylinders, etc.) is applied with a hydraulic pressure resulting from a reaction force of a spring of the accumulator (or reservoir).

In view of the foregoing, it is desirable to provide a brake control apparatus capable of maximizing the amount of regeneration by suppressing the wheel cylinders from being applied with a hydraulic pressure when the regenerative braking is operating.

According to one aspect of the present invention, a brake control apparatus is provided for a vehicle, wherein: the vehicle includes: a hydraulic braking system configured to generate a first braking force by controlling hydraulic pressure of brake fluid in each of wheel cylinders, wherein each wheel cylinder is provided at a corresponding one of road wheels; and a regenerative braking system configured to generate a second braking force electrically at the road wheels; and the vehicle is configured to be braked by the first braking force generated by the hydraulic braking system and the second braking force generated by the regenerative braking system; and wherein the brake control apparatus comprises: a fluid storing section configured to store a quantity of brake fluid that is flown out of a master cylinder by driver's braking operation; pressure-increasing control valves each of which is disposed between the master cylinder and a corresponding one of the wheel cylinders; a master cylinder pressure reduction control valve disposed in a fluid passage connected between the master cylinder and the fluid storing section; and a hydraulic pressure control section configured to perform a control operation when the second braking force is being controlled with the regenerative braking system, wherein the control operation includes: controlling at least one of the pressure-increasing control valves toward closed state; controlling the master cylinder pressure reduction control valve toward open state; and allowing the quantity of brake fluid to flow into the fluid storing section.

According to another aspect of the present invention, a brake control apparatus is provided for a vehicle, wherein: the vehicle includes: a hydraulic braking system configured to generate a first braking force by controlling hydraulic pressure of brake fluid in each of wheel cylinders, wherein each wheel cylinder is provided at a corresponding one of road wheels; and a regenerative braking system configured to generate a second braking force electrically at the road wheels; and the vehicle is configured to be braked by the first braking force generated by the hydraulic braking system and the second braking force generated by the regenerative braking system; and wherein the brake control apparatus comprises: pressure-increasing control valves each of which is disposed between a master cylinder and a corresponding one of the wheel cylinders; a fluid storing section configured to receive inflow of brake fluid; pressure-reducing control valves each of which is disposed between the fluid storing section and a corresponding one of the wheel cylinders; and a hydraulic pressure control section configured to perform a control operation, when allowing a quantity of brake fluid to flow into the fluid storing section, wherein the quantity of brake fluid is flown out of the master cylinder by driver's braking operation, while the second braking force is being controlled with the regenerative braking system, wherein the control operation includes: controlling at least one of the pressure-increasing control valves toward closed state, and controlling at least one of the pressure-increasing control valves toward open state except the at least one of the pressure-increasing control valves being controlled toward closed state; and controlling toward open state at least one of the pressure-reducing control valves corresponding to at least one of the pressure-increasing control valves being controlled toward open state.

According to a further aspect of the present invention, a brake control apparatus is provided for a vehicle, wherein: the vehicle includes: a hydraulic braking system configured to generate a first braking force by controlling hydraulic pressure of brake fluid in each of wheel cylinders, wherein each wheel cylinder is provided at a corresponding one of road wheels; and a second braking system configured to generate a second braking force; and the vehicle is configured to be braked by the first braking force generated by the hydraulic braking system and the second braking force generated by the second braking system; and wherein the brake control apparatus comprises: a braking operation detecting section configured to detect driver's braking operation; pressure-increasing control valves each of which is disposed between a master cylinder and a corresponding one of the wheel cylinders; a reservoir into which brake fluid flows from the wheel cylinders when an anti-lock braking system of the vehicle is performing a pressure-reducing operation; pressure-reducing control valves each of which is disposed between the reservoir and a corresponding one of the wheel cylinders; and a hydraulic pressure control section configured to perform a control operation in response to detection of driver's braking operation by the braking operation detecting section, wherein the control operation includes: controlling at least one of the pressure-increasing control valves toward closed state; controlling at least one of the pressure-increasing control valves toward open state except the at least one of the pressure-increasing control valves being controlled toward closed state; controlling toward open state at least one of the pressure-reducing control valves corresponding to at least one of the pressure-increasing control valves being controlled toward open state; allowing fluid communication between the master cylinder and the reservoir; and preventing fluid communication between the master cylinder and at least one of the wheel cylinders.

### BRIEF DESCRIPTION OF THE DRAWINGS

FIG. 1 is a schematic diagram showing a drive/brake system of a hybrid electric vehicle provided with a brake control apparatus according to a first embodiment of the present invention.

FIG. 2 is a schematic diagram showing a hydraulic circuit of the brake control apparatus according to the first embodiment.

FIG. 3 is a schematic diagram showing the hydraulic circuit of the brake control apparatus during cooperative regenerative braking control according to the first embodiment.

FIG. 4 is a time chart showing operation of the brake control apparatus according to a comparative example.

FIG. 5 is a time chart showing operation of the brake control apparatus according to the first embodiment.

FIG. 6 is a schematic diagram showing a hydraulic circuit of a brake control apparatus according to a second embodiment of the present invention.

FIG. 7 is a schematic diagram showing a hydraulic circuit of a brake control apparatus according to a third embodiment of the present invention.

### DETAILED DESCRIPTION OF THE INVENTION

### First Embodiment

<System Configuration>

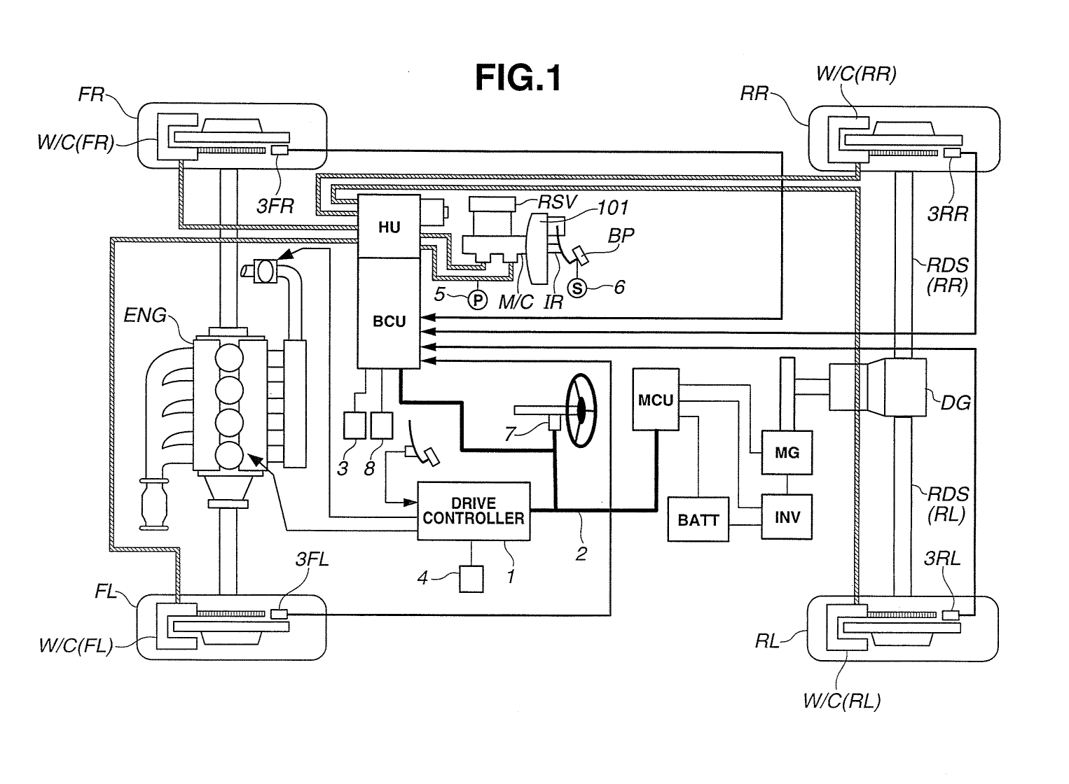

FIG. 1 schematically shows a drive/brake system of a hybrid electric vehicle provided with a brake control apparatus according to a first embodiment of the present invention. In response to a command signal from a brake control unit BCU, a hydraulic pressure control unit HU increases or reduces or holds the internal hydraulic pressure of each of a left front wheel cylinder W/C(FL) at a left front road wheel FL, a right front wheel cylinder W/C(FR) at a right front road wheel FR, a left rear wheel cylinder W/C(RL) at a left rear road wheel RL, and a right rear wheel cylinder W/C(RR) at a right rear road wheel RR. Hydraulic pressure control unit HU and brake control unit BCU constitute a hydraulic braking system for producing a braking force by controlling hydraulic pressure of brake fluid in wheel cylinders W/C provided at corresponding ones of the road wheels.

A motor generator MG is a three-phase alternating-current motor. Motor generator MG is coupled to a left rear drive shaft RDS(RL) for left rear road wheel RL and a right rear drive shaft RDS(RR) for right rear road wheel RR through a differential gear DG. Motor generator MG rotates in power run state or in regeneration run state, and applies to left and right rear road wheels RL, RR driving forces or regenerative braking forces, depending on a command from a motor control unit MCU.

An inverter INV receives a command signal from motor control unit MCU, and performs based on the command signal a conversion to an alternating current from a direct current supplied from a battery BATT, and supplies the converted current to motor generator MG so that motor generator MG rotates under power. On the other hand, in response to a command signal from motor control unit MCU, inverter INV allows motor generator MG to run in regenerative mode, by performing a conversion to a direct current from an alternating current generated at motor generator MG, and supplying the converted current to battery BATT for charging the same.

Motor control unit MCU receives a command signal from a drive controller 1, and outputs to inverter INV a command signal that is generated depending on the received command signal. In response to a command signal from brake control unit BCU, motor control unit MCU outputs a command signal to inverter INV. Motor control unit MCU sends information to brake control unit BCU and drive controller 1 through a communication line 2, wherein the information includes a condition of output control of driving torque or regenerative braking torque of motor generator MG, and an upper limit of regenerative braking torque generated by motor generator MG (or an upper limit of regenerative braking force at road wheels). This upper limit may be calculated based on an estimated value of a battery SOC (state of charge) which is obtained with reference to the terminal voltage and current of battery BATT, and based on an estimated or calculated value of vehicle body speed or vehicle speed. When the vehicle is turning, the upper limit may be calculated in account of steer characteristics of the vehicle. Specifically, when the battery SOC is at or close to a full level, the upper limit is set in consideration of preventing the battery BATT from being overcharged, and thereby protecting the battery BATT. When the vehicle is decelerated by braking, the maximum possible value of regenerative braking force decreases as the vehicle speed decreases. On the other hand, when the vehicle is traveling at high speed, regenerative braking operation may cause a high load applied to inverter INV. In view of the foregoing, the upper limit of regenerative braking force is set or regenerative braking is inhibited, for protection of inverter INV.

The setting of the upper limit of regenerative braking force is further advantageous as follows. In the case of the vehicle according to this embodiment, regenerative braking torque is applied to the rear wheels. If the regenerative braking force is excessively higher than the frictional braking force when the vehicle is turning, namely, if the total braking force of rear wheels is excessively higher than the total braking force of front wheels, the vehicle may fall in oversteer tendency, so that turning behavior of the vehicle may become unstable. In such situations, it is desirable to conform braking force distribution between the front side and the rear side during turning to an ideal one determined by specifications of the vehicle (front:rear=6:4, for example). This problem is solved by the setting of the upper limit of regenerative braking force in this embodiment. Motor generator MG, inverter INV, battery BATT, and motor control unit MCU constitute a regenerative braking system for producing a regenerative force at the road wheels (left and right rear road wheels RL, RR, in this example).

Drive controller 1 receives information from various sensors (accelerator opening from an accelerator opening sensor 4, vehicle speed (vehicle body speed) calculated by road wheel speed sensor 3, battery SOC, etc.) directly or through the communication line 2, and performs various control operations depending on the received information, wherein the control operations include a control operation of controlling the engine ENG, a control operation of controlling operation of an automatic transmission not shown, and a control operation of controlling operation of motor generator MG by outputting a drive command to motor control unit MCU. Brake control unit BCU receives input of information from various sensors directly or through the communication line 2. The sensors include a master cylinder pressure sensor 5 for obtaining and providing information about master cylinder pressure, and a brake pedal stroke sensor 6 as a braking operation detecting section for obtaining and providing information about brake pedal stroke, and a steering wheel angle sensor 7 for obtaining and providing information about steering wheel angle, and a road wheel speed sensor 3 for obtaining and providing information about road wheel speeds, and a yaw rate sensor 8 for obtaining and providing information about vehicle body yaw rate. Brake control unit BCU also receives input of information about battery SOC, etc., through the communication line 2.

Brake control unit BCU is configured to calculate or estimate a driver request value of braking force, based on information about master cylinder pressure and brake pedal stroke. Brake control unit BCU allocates the driver request value of braking force to a component of regenerative braking force and a component of frictional braking force, and controls operation of hydraulic pressure control unit HU to achieve a desired frictional braking force, and outputs a command signal to motor control unit MCU to control operation of motor generator MG to achieve a desired regenerative braking force.

In the present embodiment, a cooperative regenerative braking control is performed in which regenerative braking is prioritized higher than frictional braking so that if a driver request of braking force can be fulfilled by regenerative braking force, brake control unit BCU uses regenerative braking force only, as long as the driver requests is below the upper limit of regenerative braking force. This serves to enhance energy recovery efficiency overall from a low speed region to a high sped region, especially when the vehicle accelerates and decelerates repeatedly. When the vehicle speed decreases or increases so that the regenerative braking force is limited to the upper limit, brake control unit BCU decreases the distribution for regenerative braking force and increases the distribution for frictional braking force, for achieving the driver request. On the other hand, when the upper limit of regenerative braking force is raised to allow a relatively large regenerative braking force, brake control unit BCU increases the distribution for regenerative braking force and decreases the distribution for frictional braking force.

<Hydraulic Circuit>

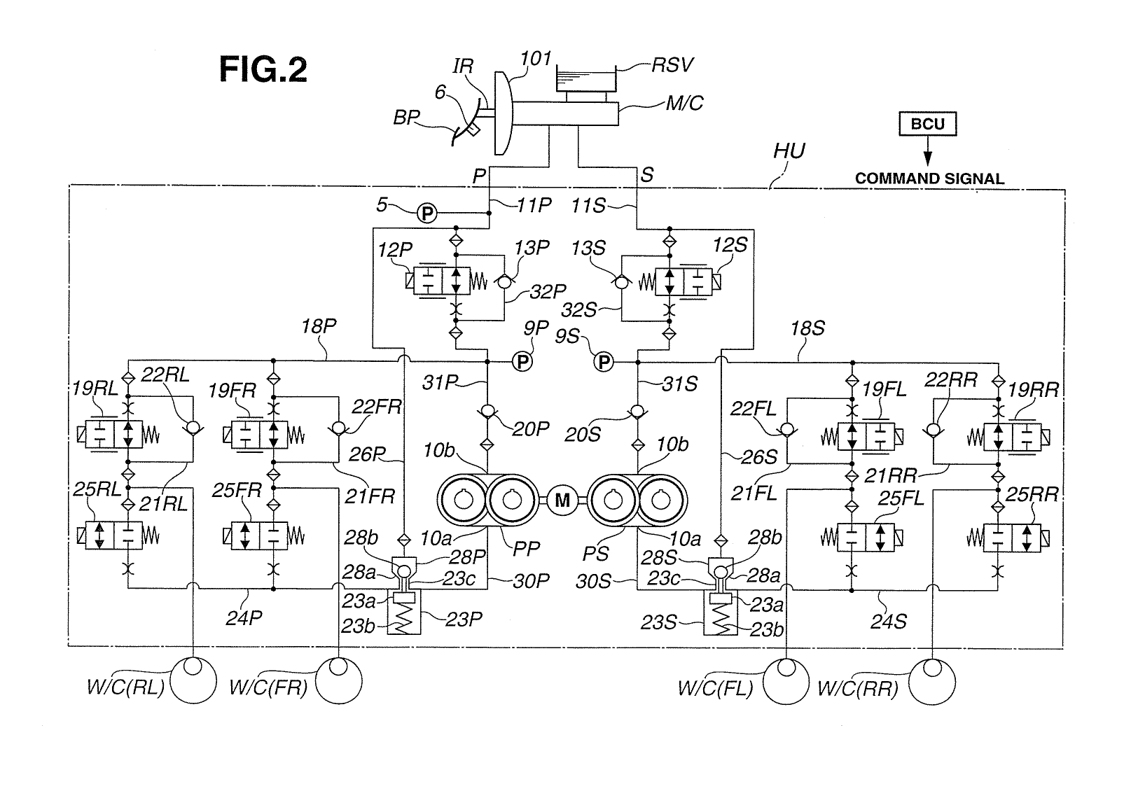

FIG. 2 schematically shows a hydraulic circuit of the brake control apparatus according to the first embodiment. The following describes specific configuration of hydraulic pressure control unit HU. Hydraulic pressure control unit HU has an X-line arrangement including a P-line section and a S-line section. The P-line section is hydraulically connected to right front wheel cylinder W/C(FR) and left rear wheel cylinder W/C(RL) for supplying brake fluid thereto, whereas the S-line section is hydraulically connected to left front wheel cylinder W/C(FL) and right rear wheel cylinder W/C(RR) for supplying brake fluid thereto. In FIG. 2, each reference symbol having a last character of “P” represents an element associated with the P-line section, whereas each reference symbol having a last character of “S” represents an element associated with the S-line section. Similarly, each reference symbol having last two characters of “FL” represents an element associated with left front road wheel FL, and each reference symbol having last two characters of “FR” represents an element associated with right front road wheel FR, and each reference symbol having last two characters of “RL” represents an element associated with left rear road wheel RL, and each reference symbol having last two characters of “RR” represents an element associated with right rear road wheel RR. In the following description, these last characters are omitted if the described feature is common between the P-line section and S-line section or among road wheels FL, FR, RL and RR for conciseness of the description.

Hydraulic pressure control unit HU employs a closed hydraulic circuit, which is a hydraulic circuit in which brake fluid supplied to wheel cylinder W/C is returned to reservoir tank RSV through master cylinder M/C. Brake pedal BP is coupled to master cylinder M/C through an input rod IR. Input rod IR is provided with a pneumatic booster 101 that is configured to boost an input of input rod IR by a pneumatic actuator as a boosting means. Reservoir tank RSV is configured to supply brake fluid to master cylinder M/C according to the amount of stroke of input rod IR, and receives and stores an excess amount of brake fluid out of master cylinder M/C.

The P-line section for right front wheel cylinder W/C(FR) and left rear wheel cylinder W/C(RL) is provided with a pump PP, whereas the S-line section for left front wheel cylinder W/C(FL) and right rear wheel cylinder W/C(RR) is provided with a pump PS. Each pump PP, PS is a gear pump in this example. Pumps PP and PS are driven by a common electric motor M. Each pump PP, PS sucks brake fluid through a suction port 10a, pressurizes the sucked brake fluid, and discharges the pressurized brake fluid through a discharge port 10b. Master cylinder M/C and the discharge port 10b of pump P is connected to each other through a fluid passage 11 and a fluid passage 31. Fluid passage 11 is provided with a gate-out valve 12 therein. Gate-out valve 12 is a normally open proportional electromagnetic valve that is fully opened when in de-energized state, and is operated toward closed state when in energized state. Fluid passage 11 is provided with a fluid passage 32 that bypasses the gate-out valve 12. Fluid passage 32 is provided with a check valve 13 therein. Check valve 13 is a unidirectional valve that permits brake fluid to flow in a direction from master cylinder M/C to wheel cylinder W/C, and prevents brake fluid from inversely flowing. Fluid passage 11P in the P-line section is provided with a master cylinder pressure sensor 5 therein in a section between master cylinder M/C and gate-out valve 12P. Fluid passage 31 is provided with a check valve 20 therein. Check valve 20 is a unidirectional valve that permits brake fluid to flow in a direction from pump P to fluid passage 11, and prevents brake fluid from inversely flowing. The connection point between fluid passage 11 and fluid passage 31 is provided with a pump discharge pressure sensor 9 therein. Pump discharge pressure sensor 9 is configured to sense a discharge pressure of pump P.

The discharge port 10b of pump P and wheel cylinder W/C are connected to each other through a fluid passage 18. Fluid passage 18 is provided with a solenoid in-valve 19 therein. Solenoid in-valve 19 is a normally open proportional electromagnetic valve, serving as a pressure-increasing valve for a corresponding one of the wheel cylinders W/C. Solenoid in-valve 19 includes a valve element that is arranged in a direction such that solenoid in-valve 19 is closed by a master cylinder pressure, namely, arranged to close in a direction against application of the master cylinder pressure. When solenoid in-valve 19 is closed, solenoid in-valve 19 is applied with an electric current such that solenoid in-valve 19 can be maintained closed under a specific master cylinder pressure. Fluid passage 18 is provided with a fluid passage 21 bypassing the solenoid in-valve 19. Fluid passage 21 is provided with a check valve 22 therein. Check valve 22 is a unidirectional valve that permits brake fluid to flow in a direction from wheel cylinder W/C to pump P, and prevents brake fluid from inversely flowing. Fluid passage 18 is connected to the connection point between fluid passage 11 and fluid passage 31. Wheel cylinder W/C and a reservoir (fluid storing section) 23 are connected to each other through a fluid passage 24. Fluid passage 24 is provided with a solenoid out-valve 25 therein. Solenoid out-valve 25 is a normally closed electromagnetic valve that is fully closed when in de-energized state, and is operated toward open state when in energized state. Solenoid out-valve 25 serves as a pressure-reducing valve for a corresponding one of the wheel cylinders W/C, and constitutes a master cylinder pressure reduction control valve. Master cylinder M/C and reservoir 23 are connected to each other through a fluid passage 26. Reservoir 23 and the suction port 10a of pump P are connected to each other through a fluid passage 30.

Reservoir 23 includes a piston 23a and a gas spring 23b, wherein gas spring 23b presses piston 23a. Reservoir 23 is provided with a check valve 28 in fluid passage 26, wherein check valve 28 is of a pressure-sensitive type. Check valve 28 includes a seat portion 28a and a valve element 28b, wherein seat portion 28a is formed at a port 23c of reservoir 23, and valve element 28b is configured to be in contact with seat portion 28a. Valve element 28b is formed integrally with piston 23a of reservoir 23. When a predetermined amount of brake fluid is stored in reservoir 23, and when the internal pressure of fluid passage 26 becomes higher than a predetermined value, check valve 28 is closed so that valve element 28b gets in contact with seat portion 28a, thereby preventing inflow of brake fluid into reservoir 23, and preventing the suction port 10a of pump P from being applied with high pressure. When the internal pressure of fluid passage 30 falls due to operation of pump P, valve element 28b gets out of contact with seat portion 28a so that check valve 28 opens, regardless of the internal pressure of fluid passage 26, thereby allowing brake fluid to flow into reservoir 23.

<Control of Anti-Lock Braking System>

When detecting that a road wheel tend to be in lock state by driver's braking operation, brake control unit BCU performs an anti-lock braking system (ABS) control operation by repeatedly reducing, holding, and increasing the wheel cylinder pressure of the target road wheel, in order to maximize the braking force while preventing the road wheel from locking. During ABS pressure-reducing control, brake control unit BCU shifts from the condition shown in FIG. 2 by closing the solenoid in-valve 19, and opening the solenoid out-valve 25, to allow brake fluid to flow out of wheel cylinder W/C into reservoir 23, and thereby reduce the wheel cylinder pressure. During ABS pressure-holding control, brake control unit BCU holds the wheel cylinder pressure by closing both of solenoid in-valve 19 and solenoid out-valve 25. During ABS pressure-increasing control, brake control unit BCU increases the wheel cylinder pressure by opening the solenoid in-valve 19, closing the solenoid out-valve 25, and operating the pump P to supply brake fluid from reservoir 23 to wheel cylinder W/C. In a situation where the anti-lock braking system is activated when the regenerative braking force is being generated by the regenerative braking system, namely, when cooperative regenerative braking control is being performed, brake control unit BCU sets the regenerative braking force to zero, and quickly raises the frictional braking force, and thus gradually replaces the regenerative braking force with the frictional braking force. Hydraulic pressure control unit HU is configured to perform an automatic braking control which serves for a vehicle behavior stabilizing control, a brake assist control, an auto-cruise control, etc., in addition to the anti-lock braking system control described above, wherein during the vehicle behavior stabilizing control, hydraulic pressure control unit HU serves to stabilize the vehicle behavior by controlling the wheel cylinder pressure of the road wheel to be controlled, in response to detection that the vehicle is falling in increased oversteer tendency or understeer tendency, wherein during the brake assist control, hydraulic pressure control unit HU produces a higher hydraulic pressure in the wheel cylinder W/C than the hydraulic pressure of master cylinder M/C caused directly by driver's braking operation, and wherein during auto-cruise control, hydraulic pressure control unit HU automatically produces a braking force according to a positional relationship between the host vehicle and the preceding vehicle.

<Cooperative Regenerative Braking Control>

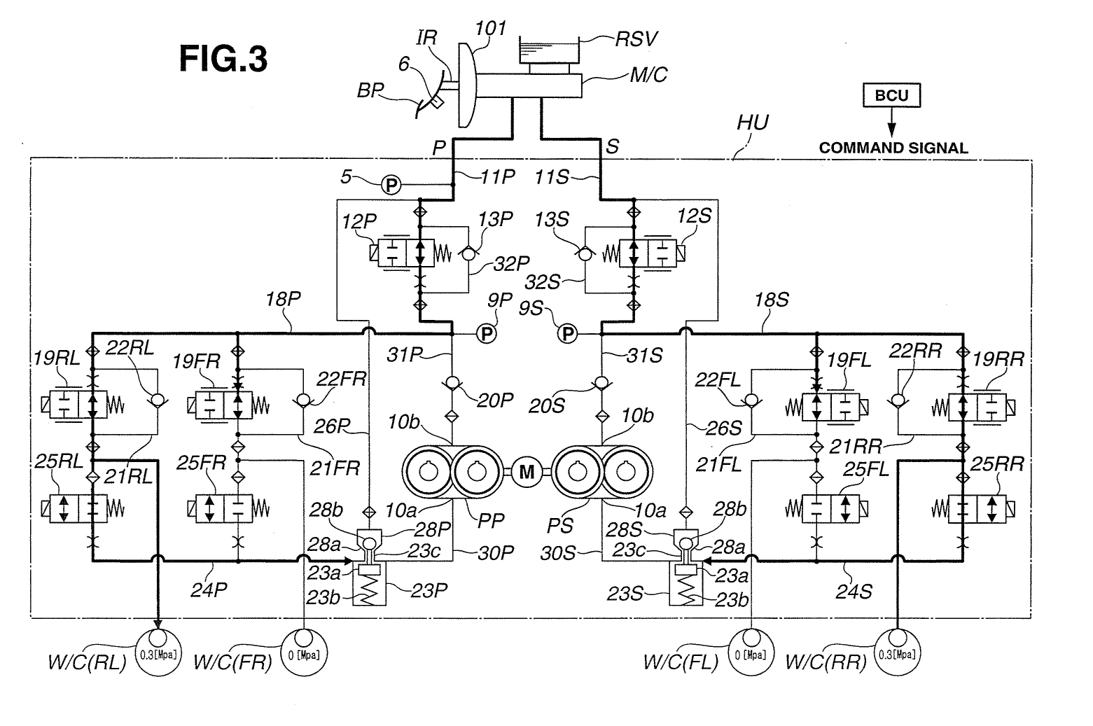

FIG. 3 is a schematic diagram showing the hydraulic circuit of the brake control apparatus during cooperative regenerative braking control. In response to detection of driver's braking operation, brake control unit BCU controls the solenoid in-valves 19FL, 19FR of the front road wheels toward closed state, and controls the solenoid out-valves 25RL, 25RR of the rear road wheels toward open state. When the solenoid in-valves 19FL, FR of the front road wheels are closed, no brake fluid is supplied to and no hydraulic pressure is applied to left and right front wheel cylinders W/C(FL), W/C(FR). On the other hand, since the solenoid in-valves 19RL, 19RR of the rear road wheels are opened, a brake fluid pressure is applied to left and right rear wheel cylinders W/C(RL), W/C(RR). However, since the solenoid out-valves 25RL, 25RR of the rear road wheels are also opened, so that brake fluid is drained from left and right rear wheel cylinders W/C(RL), W/C(RR) and stored in reservoir 23, and the brake fluid pressure applied to left and right rear wheel cylinders W/C(RL), W/C(RR) is lower than or equal to an activation pressure of reservoir 23 that is about 0.3 [MPa] in this example.

The setting described above serves to increase the amount of regeneration, and thereby enhance the fuel efficiency, when the regenerative braking system is producing the regenerative braking force. This does not adversely affect braking operation feel of the driver, because reservoir 23 serves as a stroke simulator simulating depression of brake pedal BP when the regenerative braking system is operating. This setting may be modified so that the solenoid in-valves 19RL, 19RR of the rear wheels is closed and the solenoid out-valves 25FL, 25FR of the front wheels is opened. However, the setting that no brake fluid pressure is applied to left and right front wheel cylinders W/C(FL), W/C(FR) is more effective for increasing the distribution of regenerative braking force and thereby increase of the amount of regeneration than the setting that no brake fluid pressure is supplied to the left and right rear wheel cylinders W/C(RL), W/C(RR). When the solenoid in-valves 19FL, 19FR of the front wheels are controlled toward closed state, the solenoid of solenoid in-valve 19FL, 19FR is applied with an electric current such that the solenoid in-valve 19FL, 19FR is maintained closed when the master cylinder pressure is slightly higher than the reservoir activation pressure. This feature serves to quickly supply brake fluid also to left and right front wheel cylinders W/C(FL), W/C(FR), and thereby produce a high braking force, even when a panic braking operation (a hard braking operation performed in response to conditions unexpected by the driver) or the like occurs so that the master cylinder pressure exceeds the reservoir activation pressure.

<Operation>

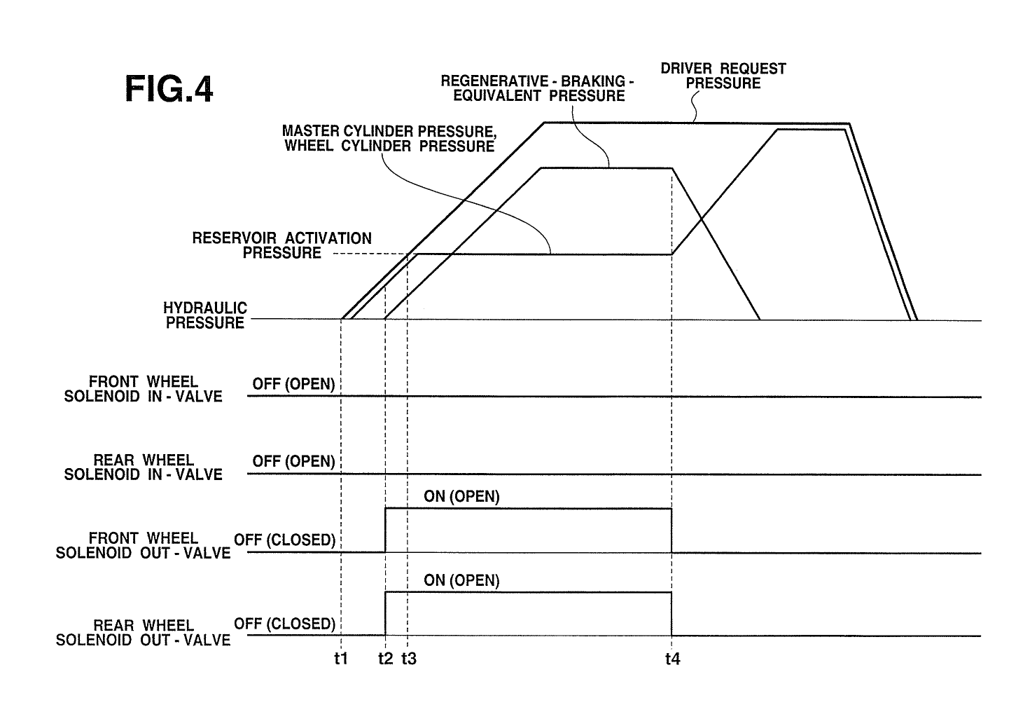

The following describes operation of the brake control apparatus according to the first embodiment. Prior to explanation of the first embodiment, a comparative example is discussed in which all of solenoid out-valves 25 of the front wheels and rear wheels are opened when the regenerative braking system is operating. The reduction of wheel cylinder pressure can be implemented by opening the solenoid out-valve 25 and thereby allow brake fluid to flow from wheel cylinder W/C into reservoir 23. FIG. 4 shows a time chart for the case of the comparative example. In FIG. 4, a driver request pressure is defined to represent a master cylinder pressure that is needed to achieve a desired braking force only with the hydraulic braking system, wherein the desired braking force is determined by the amount of depression of brake pedal BP by the driver. In FIG. 4, a regenerative-braking-equivalent pressure is defined to represent a master cylinder pressure that is needed to achieve a braking force only with the hydraulic braking system, wherein the braking force is actually generated only with the regenerative braking system.

In FIG. 4, at a time instant t1, the driver starts to depress brake pedal BP, so that the driver request pressure starts to rise, and the master cylinder pressure and the wheel cylinder pressure starts to rise as the amount of depression of brake pedal BP increases. At a time instant t2, the solenoid out-valves 25 of the front and rear wheels are opened before the master cylinder pressure and wheel cylinder pressure reach the reservoir activation pressure. This operation may be modified so that only the solenoid out-valves 25 of the front wheels or the solenoid out-valves 25 of the rear wheels are opened. At a time instant t3, the master cylinder pressure and the wheel cylinder pressure reach the reservoir activation pressure, so that brake fluid flows into reservoir 23, and thereby the master cylinder pressure and the wheel cylinder pressure are maintained at a constant level. At a time instant t4, motor control unit MCU inhibits regenerative braking, in response to a condition such as a condition that the battery SOC reaches the upper limit, so that solenoid out-valves 25 are closed, and thereby the master cylinder pressure and the wheel cylinder pressure start to increase to the driver request pressure.

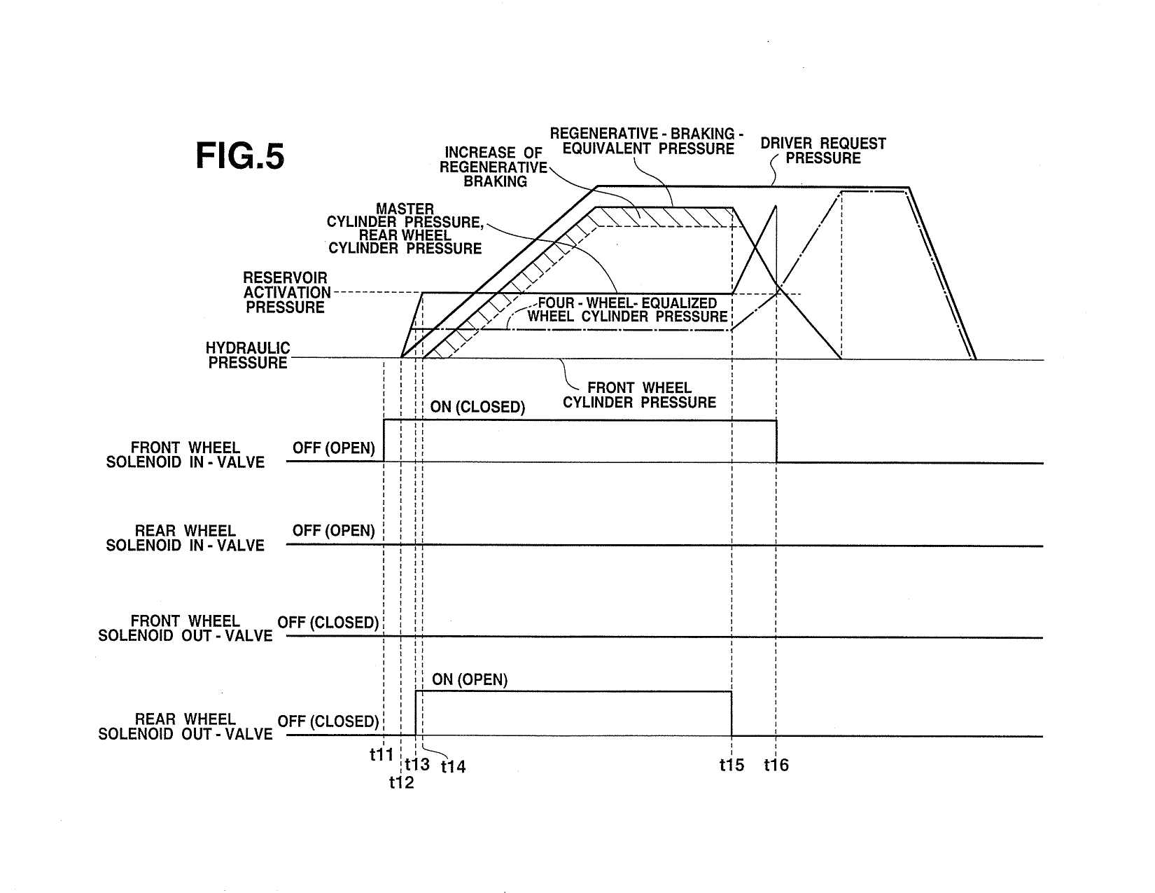

In this way, even when solenoid out-valve 25 is opened, wheel cylinder W/C is still applied with a hydraulic pressure that is equal to about the reservoir activation pressure, so that a braking force is still generated by the hydraulic braking system. The portion of braking force of the hydraulic braking system may lead to a reduction of the braking force generated by the regenerative braking system, so that the amount of regeneration may be small. In contrast to this comparative example, according to the first embodiment, when the regenerative braking system is operating, the solenoid in-valves 19FL, 19FR of the front wheels are closed, and the solenoid out-valves 25RL, 25RR of the rear wheels are opened. FIG. 5 shows a time chart for the first embodiment. In FIG. 5, a four-wheel-equalized wheel cylinder pressure is defined to represent a wheel cylinder pressure under assumption that the amount of brake fluid supplied from master cylinder M/C to wheel cylinders W/C is distributed evenly to all wheel cylinders W/C of the four wheels.

At a time instant t11, when driver's brake pedal operation is detected, the solenoid in-valves 19FL, 19FR of the front wheels are closed. Detection of driver's brake pedal operation is implemented by detecting operation of brake pedal BP within a region of play of brake pedal BP before the master cylinder pressure actually starts to rise. At a time instant t12, the driver request pressure rises as the amount of depression of brake pedal BP increases, and also the master cylinder pressure and the wheel cylinder pressure of each rear wheel rise as the amount of depression of brake pedal BP increases. In this situation, the wheel cylinder pressure of each front wheel fails to rise, because the solenoid in-valves 19FL, 19FR of the front wheels are closed. The driver request pressure is calculated as a master cylinder pressure corresponding to the amount of depression of brake pedal BP under assumption that brake fluid is supplied to all wheel cylinders W/C. Accordingly, when solenoid in-valves 19FL, 19FR of the front wheels are closed, the master cylinder pressure is higher than the deriver request pressure because the system rigidity of the hydraulic circuit of the brake control apparatus is high in this situation. At a time instant t13, solenoid out-valves 25 of the rear wheels are opened before the master cylinder pressure and the wheel cylinder pressure of each rear wheel reach the reservoir activation pressure. At a time instant t14, when the master cylinder pressure and the wheel cylinder pressure of each rear wheel reach the reservoir activation pressure, brake fluid flows into reservoir 23, so that the master cylinder pressure and the wheel cylinder pressure of each rear wheel are maintained at a constant level. When the regenerative braking force occurs according to the amount of depression of brake pedal BP, an increased regenerative braking force results in an increase of the amount of regeneration as indicated by a hatched pattern in FIG. 5, because the wheel cylinder pressure of each front wheel is equal to zero.

At a time instant t15, motor control unit MCU inhibits regenerative braking, in response to a condition such as a condition that the battery SOC reaches the upper limit, so that solenoid out-valves 25 of the rear wheels are closed, and thereby the master cylinder pressure and the wheel cylinder pressure of each rear wheel increase. Accordingly, the four-wheel-equalized wheel cylinder pressure increases. At a time instant t16, when the four-wheel-equalized wheel cylinder pressure reaches the reservoir activation pressure, the solenoid in-valves 19FL, 19FR of the front wheels are opened, so that brake fluid flows from the left and right rear wheel cylinders W/C(RL), W/C(RR) to the left and right front wheel cylinders W/C(FL), W/C(FR), and thereby each wheel cylinder pressure becomes equal to the reservoir activation pressure. After time instant t16, the master cylinder pressure and the wheel cylinder pressure rise up to the driver request pressure. Incidentally, the regenerative-braking-equivalent pressure becomes equal to zero when the four-wheel-equalized wheel cylinder pressure becomes equal to the driver request pressure.

### ADVANTAGEOUS EFFECTS

The brake control apparatus according to the first embodiment produces the following advantageous effects.

<1> A brake control apparatus for a vehicle, wherein: the vehicle includes: a hydraulic braking system (hydraulic pressure control unit HU, brake control unit BCU) configured to generate a first braking force by controlling hydraulic pressure of brake fluid in each of wheel cylinders (W/C), wherein each wheel cylinder (W/C) is provided at a corresponding one of road wheels (FL, FR, RL, RR); and a regenerative braking system (motor generator MG, inverter INV, battery BATT, motor control unit MCU) configured to generate a second braking force electrically at the road wheels (RL, RR); and the vehicle is configured to be braked by the first braking force generated by the hydraulic braking system (HU, BCU) and the second braking force generated by the regenerative braking system (MG, INV, BATT, MCU); and wherein the brake control apparatus includes: a fluid storing section (reservoir 23) configured to store a quantity of brake fluid that is flown out of a master cylinder (M/C) by driver's braking operation; pressure-increasing control valves (solenoid in-valves 19) each of which is disposed between the master cylinder (M/C) and a corresponding one of the wheel cylinders (W/C); a master cylinder pressure reduction control valve (solenoid out-valves 25) disposed in a fluid passage (24) connected between the master cylinder (M/C) and the fluid storing section (23); and a hydraulic pressure control section (brake control unit BCU) configured to perform a control operation when the second braking force is being controlled with the regenerative braking system (MG, INV, BATT, MCU), wherein the control operation includes: controlling at least one of the pressure-increasing control valves (19) toward closed state; controlling the master cylinder pressure reduction control valve (25) toward open state; and allowing the quantity of brake fluid to flow into the fluid storing section (23), serves to produce an increased amount of regeneration when the regenerative braking system is operating.

<2> The brake control apparatus configured so that the fluid storing section (23) is a reservoir into which brake fluid flows from the wheel cylinders (W/C) when an anti-lock braking system of the vehicle is performing a pressure-reducing operation, serves to provide a function of storing brake fluid without any additional member.

<3> The brake control apparatus configured so that the master cylinder pressure reduction control valve (25) is constituted by pressure-reducing control valves each of which is disposed between the reservoir (23) and a corresponding one of the wheel cylinders (W/C), serves to provide a function of the master cylinder pressure reduction valve without any additional member.

<4> The brake control apparatus configured so that: the control operation further includes controlling at least one of the pressure-increasing control valves (19) toward open state except the at least one of the pressure-increasing control valves (19) being controlled toward closed state; and the controlling the master cylinder pressure reduction control valve (25) toward open state is implemented by controlling toward open state at least one of the pressure-reducing control valves (25) corresponding to at least one of the pressure-increasing control valves (19) being controlled toward open state, serves to increase the amount of regeneration while improving the driver's braking pedal operation feel.

<5> The brake control apparatus configured so that: each pressure-increasing control valve (19) is a normally open electromagnetic valve; each pressure-increasing control valve (19) includes a valve element arranged to close in a direction against application of pressure of the master cylinder (M/C); and each pressure-increasing control valve (19) is applied with at least an electric current that allows the pressure-increasing control valve (19) to be maintained in closed state when the pressure of the master cylinder (M/C) is equal to a predetermined value, serves to suppress electric energy consumption.

<6> The brake control apparatus further including a braking operation detecting section (brake pedal stroke sensor 6) configured to detect driver's braking operation, wherein: the fluid storing section (23) is a reservoir into which brake fluid flows from the wheel cylinders (W/C) when an anti-lock braking system of the vehicle is performing a pressure-reducing operation; the master cylinder pressure reduction control valve (25) is constituted by pressure-reducing control valves each of which is disposed between the reservoir (23) and a corresponding one of the wheel cylinders (W/C); and the hydraulic pressure control section (BCU) is configured to implement the control operation by: controlling the at least one of the pressure-increasing control valves (19) toward closed state, and controlling at least one of the pressure-increasing control valves (19) toward open state except the at least one of the pressure-increasing control valves (19) being controlled toward closed state, in response to detection of driver's braking operation by the braking operation detecting section (6); and thereafter controlling toward open state at least one of the pressure-reducing control valves (25) corresponding to at least one of the pressure-increasing control valves (19) being controlled toward open state, serves to increase the amount of regeneration while improving the driver's braking pedal operation feel.

<7> The brake control apparatus further including a pump (P) configured to suck brake fluid stored in the reservoir (23), and raise the hydraulic pressure of the wheel cylinders (W/C), wherein the hydraulic pressure control section (BCU) is configured to close the master cylinder pressure reduction control valve (25), and control the pressure-increasing control valves (19) toward open state, with the pump (P) being driven, serves to implement the pressure-increasing operation of the anti-lock braking system.

<8> The brake control apparatus configured so that the one of the pressure-increasing control valves (19) being controlled toward closed state corresponds to the wheel cylinder (W/C) of a front road wheel (FL, FR) of the vehicle, serves to increase the ratio of regenerative braking force, and thereby increase the amount of regeneration, by preventing the left and right front wheel cylinders W/C(FL), W/C(FR) from being applied with the brake fluid pressure, wherein left and right front wheel cylinders W/C(FL), W/C(FR) normally contribute to a relatively large part of the braking force.

<9> A brake control apparatus for a vehicle, wherein: the vehicle includes: a hydraulic braking system (HU, BCU) configured to generate a first braking force by controlling hydraulic pressure of brake fluid in each of wheel cylinders (W/C), wherein each wheel cylinder (W/C) is provided at a corresponding one of road wheels (FL, FR, RL, RR); and a regenerative braking system (MG, INV, BATT, MCU) configured to generate a second braking force electrically at the road wheels (RL, RR); and the vehicle is configured to be braked by the first braking force generated by the hydraulic braking system (HU, BCU) and the second braking force generated by the regenerative braking system (MG, INV, BATT, MCU); and wherein the brake control apparatus includes: pressure-increasing control valves (19) each of which is disposed between a master cylinder (M/C) and a corresponding one of the wheel cylinders (W/C); a fluid storing section (23) configured to receive inflow of brake fluid; pressure-reducing control valves (25) each of which is disposed between the fluid storing section (23) and a corresponding one of the wheel cylinders (W/C); and a hydraulic pressure control section (BCU) configured to perform a control operation, when allowing a quantity of brake fluid to flow into the fluid storing section (23), wherein the quantity of brake fluid is flown out of the master cylinder (M/C) by driver's braking operation, while the second braking force is being controlled with the regenerative braking system (MG, INV, BATT, MCU), wherein the control operation includes: controlling at least one of the pressure-increasing control valves (19) toward closed state, and controlling at least one of the pressure-increasing control valves (19) toward open state except the at least one of the pressure-increasing control valves (19) being controlled toward closed state; and controlling toward open state at least one of the pressure-reducing control valves (25) corresponding to at least one of the pressure-increasing control valves (19) being controlled toward open state, serves to produce an increased amount of regeneration when the regenerative braking system is operating.

<10> A brake control apparatus for a vehicle, wherein: the vehicle includes: a hydraulic braking system (HU, BCU) configured to generate a first braking force by controlling hydraulic pressure of brake fluid in each of wheel cylinders (W/C), wherein each wheel cylinder (W/C) is provided at a corresponding one of road wheels (FL, FR, RL, RR); and a second braking system (MG, INV, BATT, MCU) configured to generate a second braking force; and the vehicle is configured to be braked by the first braking force generated by the hydraulic braking system (HU, BCU) and the second braking force generated by the second braking system (MG, INV, BATT, MCU); and wherein the brake control apparatus includes: a braking operation detecting section (6) configured to detect driver's braking operation; pressure-increasing control valves (19) each of which is disposed between a master cylinder (M/C) and a corresponding one of the wheel cylinders (W/C); a reservoir (23) into which brake fluid flows from the wheel cylinders (W/C) when an anti-lock braking system of the vehicle is performing a pressure-reducing operation; pressure-reducing control valves (25) each of which is disposed between the reservoir (23) and a corresponding one of the wheel cylinders (W/C); and a hydraulic pressure control section (BCU) configured to perform a control operation in response to detection of driver's braking operation by the braking operation detecting section (6), wherein the control operation includes: controlling at least one of the pressure-increasing control valves (19) toward closed state; controlling at least one of the pressure-increasing control valves (19) toward open state except the at least one of the pressure-increasing control valves (19) being controlled toward closed state; controlling toward open state at least one of the pressure-reducing control valves (25) corresponding to at least one of the pressure-increasing control valves (19) being controlled toward open state; allowing fluid communication between the master cylinder (M/C) and the reservoir (23); and preventing fluid communication between the master cylinder (M/C) and at least one of the wheel cylinders (W/C), serves to produce an increased amount of regeneration when the regenerative braking system is operating.

### Other Embodiments

The first embodiment may be modified in various manners, as follows.

### Second Embodiment

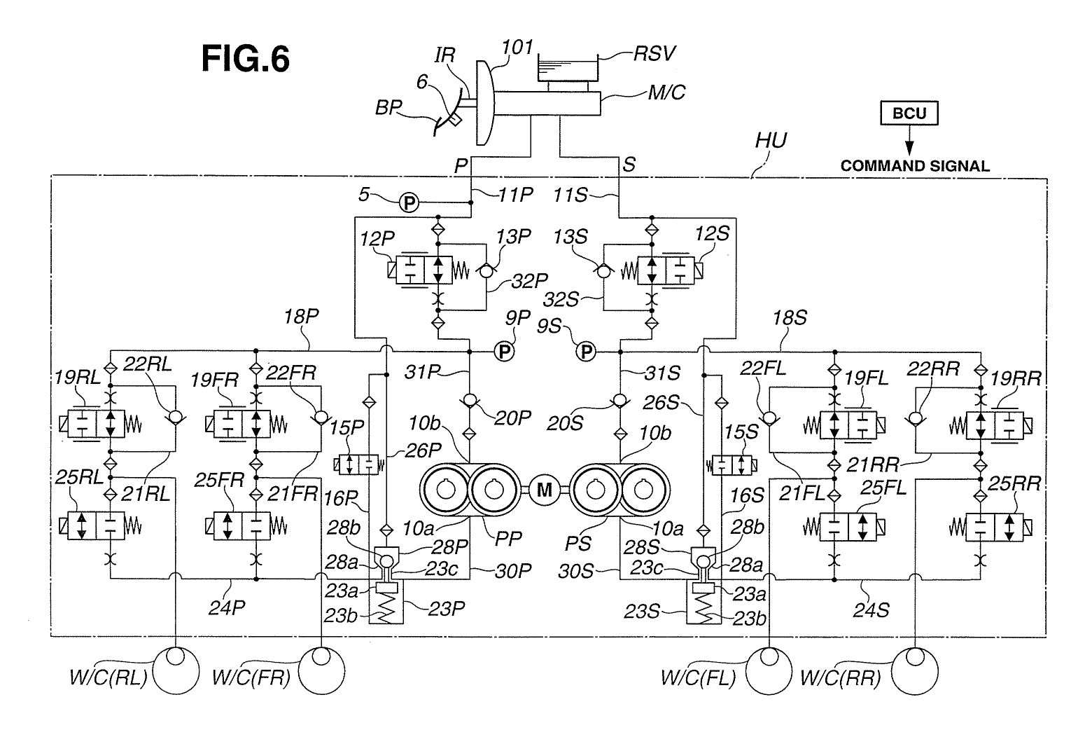

FIG. 6 schematically shows a hydraulic circuit of a brake control apparatus according to a second embodiment of the present invention. The second embodiment is different from the first embodiment in that a regenerative braking cooperation solenoid out-valve 15 is provided as a master cylinder pressure reduction control valve. Specifically, as shown in FIG. 6, a fluid passage 16 is provided to connect fluid passage 26 and fluid passage 24 directly, without passing through the check valve 28. Fluid passage 16 is provided with regenerative braking cooperation solenoid out-valve 15 therein. Regenerative braking cooperation solenoid out-valve 15 is a normally closed electromagnetic valve. In the first embodiment, when detecting driver's braking operation, brake control unit BCU controls solenoid in-valves 19FL, 19FR of the front wheels toward closed state, and solenoid out-valves 25RL, 25RR of the rear wheels toward open state. In contrast, in the second embodiment, solenoid in-valves 19 of all the four wheels are controlled toward closed state, and regenerative braking cooperation solenoid out-valve 15 is controlled toward open state. Accordingly, when the regenerative braking system is operating, the brake fluid in master cylinder M/C flows out through fluid passage 16 to reservoir 23 without passing through the wheel cylinders W/C. This prevents the wheel cylinders W/C of all the four wheels from being applied with brake fluid pressure, and thereby increases the amount of regeneration produced by the regenerative braking system.

### Third Embodiment

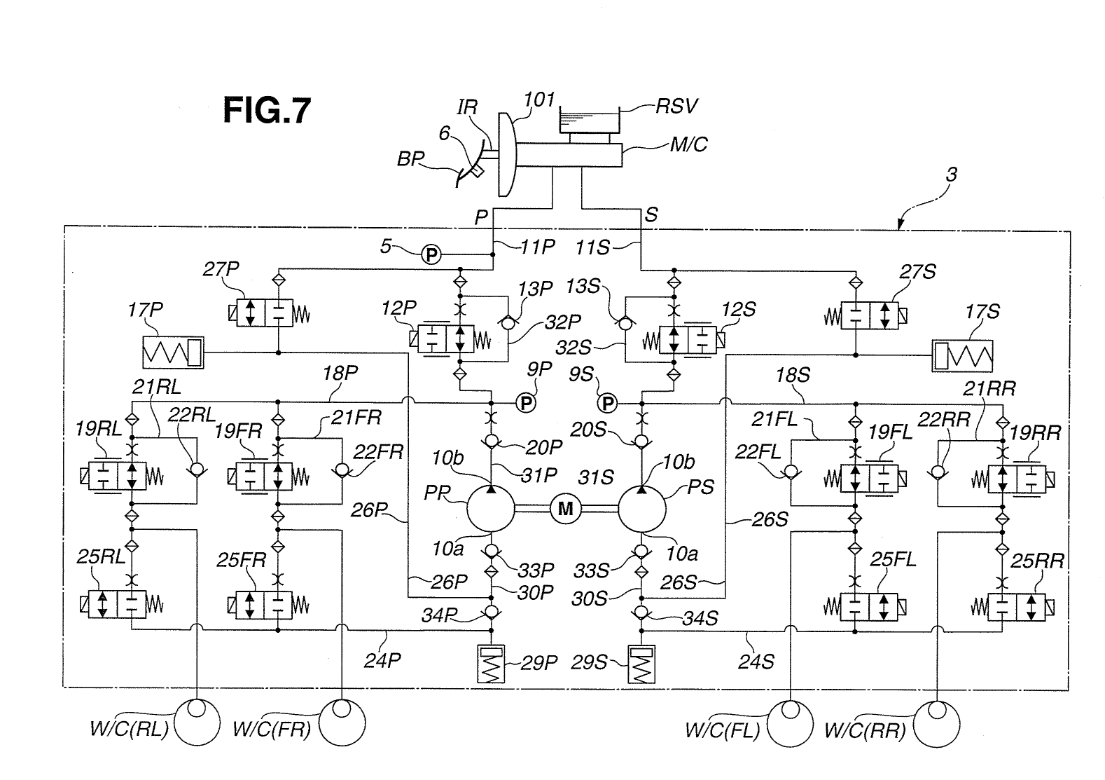

FIG. 7 schematically shows a hydraulic circuit of a brake control apparatus according to a third embodiment of the present invention. The third embodiment is different from the first embodiment in that the hydraulic circuit is constituted by twelve valves, in contrast to the first embodiment which employs ten valves. As shown in FIG. 7, wheel cylinder W/C is connected to reservoir (fluid storing section) 29 through fluid passage 24. Reservoir 29 is not provided with check valve 28 as in the first embodiment. Master cylinder M/C is connected to reservoir 23 through fluid passage 26. Fluid passage 26 is connected to a section of fluid passage 30 between the suction port 10a of pump P and reservoir 29. Fluid passage 30 is provided with a check valve 33 in a section of fluid passage 30 between pump P and fluid passage 26. Check valve 33 permits brake fluid to flow toward pump P, and inhibits brake fluid from flowing inversely. Fluid passage 30 is provided with a check valve 34 in a section of fluid passage 30 between reservoir 29 and fluid passage 26. Check valve 34 permits brake fluid to flow toward pump P from reservoir 29, and inhibits brake fluid from flowing inversely.

Fluid passage 26 is provided with a gate-out valve 27 as a master cylinder pressure reduction control valve. Gate-out valve 27 is a normally closed electromagnetic valve. Fluid passage 26 is provided with a regenerative braking cooperation reservoir 17 in a section of fluid passage 26 between gate-out valve 27 and fluid passage 30. In the first embodiment, when detecting driver's braking operation, brake control unit BCU controls the solenoid in-valves 19FL, 19FR of the front wheels toward closed state, and controls the solenoid out-valves 25RL, 25RR of the rear wheels toward open state. In contrast, in the third embodiment, the solenoid in-valves 19 of all the four wheels are controlled toward closed state, and gate-out valve 27 is controlled toward open state. Accordingly, when the regenerative braking system is operating, the brake fluid in master cylinder M/C flows out through fluid passage 26 into regenerative braking cooperation reservoir 17 without passing through the wheel cylinders W/C. This prevents the wheel cylinders W/C of all the four wheels from being applied with brake fluid pressure, and thereby increase the amount of regeneration produced by the regenerative braking system.

The entire contents of Japanese Patent Application 2012-209130 filed Sep. 24, 2012 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus for a vehicle, wherein: the vehicle includes: a hydraulic braking system configured to generate a first braking force by controlling hydraulic pressure of brake fluid in each of wheel cylinders, wherein each wheel cylinder is provided at a corresponding one of road wheels; and a regenerative braking system configured to generate a second braking force electrically at the road wheels; and the vehicle is configured to be braked by the first braking force generated by the hydraulic braking system and the second braking force generated by the regenerative braking system; and wherein the brake control apparatus comprises:
a fluid storing section configured to store a quantity of brake fluid that is flown out of a master cylinder by driver's braking operation;
pressure-increasing control valves each of which is disposed between the master cylinder and a corresponding one of the wheel cylinders;
a master cylinder pressure reduction control valve disposed in a fluid passage connected between the master cylinder and the fluid storing section; and
a hydraulic pressure control section configured to perform a control operation when the second braking force is being controlled with the regenerative braking system, wherein the control operation includes:
controlling at least one of the pressure-increasing control valves toward closed state;
controlling the master cylinder pressure reduction control valve toward open state; and
allowing the quantity of brake fluid to flow into the fluid storing section.

2. The brake control apparatus as claimed in claim 1, wherein the fluid storing section is a reservoir into which brake fluid flows from the wheel cylinders when an anti-lock braking system of the vehicle is performing a pressure-reducing operation.

3. The brake control apparatus as claimed in claim 2, wherein the master cylinder pressure reduction control valve is constituted by pressure-reducing control valves each of which is disposed between the reservoir and a corresponding one of the wheel cylinders.

4. The brake control apparatus as claimed in claim 3, wherein:
the control operation further includes controlling at least one of the pressure-increasing control valves toward open state except the at least one of the pressure-increasing control valves being controlled toward closed state; and
the controlling the master cylinder pressure reduction control valve toward open state is implemented by controlling toward open state at least one of the pressure-reducing control valves corresponding to at least one of the pressure-increasing control valves being controlled toward open state.

5. The brake control apparatus as claimed in claim 1, wherein:
each pressure-increasing control valve is a normally open electromagnetic valve;
each pressure-increasing control valve includes a valve element arranged to close in a direction against application of pressure of the master cylinder; and
each pressure-increasing control valve is applied with at least an electric current that allows the pressure-increasing control valve to be maintained in closed state when the pressure of the master cylinder is equal to a predetermined value.

6. The brake control apparatus as claimed in claim 1, further comprising a braking operation detecting section configured to detect driver's braking operation, wherein:
the fluid storing section is a reservoir into which brake fluid flows from the wheel cylinders when an anti-lock braking system of the vehicle is performing a pressure-reducing operation;
the master cylinder pressure reduction control valve is constituted by pressure-reducing control valves each of which is disposed between the reservoir and a corresponding one of the wheel cylinders; and
the hydraulic pressure control section is configured to implement the control operation by:
controlling the at least one of the pressure-increasing control valves toward closed state, and controlling at least one of the pressure-increasing control valves toward open state except the at least one of the pressure-increasing control valves being controlled toward closed state, in response to detection of driver's braking operation by the braking operation detecting section; and
thereafter controlling toward open state at least one of the pressure-reducing control valves corresponding to at least one of the pressure-increasing control valves being controlled toward open state.

7. The brake control apparatus as claimed in claim 6, further comprising a pump configured to suck brake fluid stored in the reservoir, and raise the hydraulic pressure of the wheel cylinders, wherein the hydraulic pressure control section is configured to close the master cylinder pressure reduction control valve, and control the pressure-increasing control valves toward open state, with the pump being driven.

8. The brake control apparatus as claimed in claim 1, wherein the one of the pressure-increasing control valves being controlled toward closed state corresponds to the wheel cylinder of a front road wheel of the vehicle.

9. A brake control apparatus for a vehicle, wherein: the vehicle includes: a hydraulic braking system configured to generate a first braking force by controlling hydraulic pressure of brake fluid in each of wheel cylinders, wherein each wheel cylinder is provided at a corresponding one of road wheels; and a regenerative braking system configured to generate a second braking force electrically at the road wheels; and the vehicle is configured to be braked by the first braking force generated by the hydraulic braking system and the second braking force generated by the regenerative braking system; and wherein the brake control apparatus comprises:
pressure-increasing control valves each of which is disposed between a master cylinder and a corresponding one of the wheel cylinders;
a fluid storing section configured to receive inflow of brake fluid;
pressure-reducing control valves each of which is disposed between the fluid storing section and a corresponding one of the wheel cylinders; and
a hydraulic pressure control section configured to perform a control operation, when allowing a quantity of brake fluid to flow into the fluid storing section, wherein the quantity of brake fluid is flown out of the master cylinder by driver's braking operation, while the second braking force is being controlled with the regenerative braking system, wherein the control operation includes:
controlling at least one of the pressure-increasing control valves toward closed state, and controlling at least one of the pressure-increasing control valves toward open state except the at least one of the pressure-increasing control valves being controlled toward closed state; and
controlling toward open state at least one of the pressure-reducing control valves corresponding to at least one of the pressure-increasing control valves being controlled toward open state.

10. The brake control apparatus as claimed in claim 9, wherein the fluid storing section is a reservoir into which brake fluid flows from the wheel cylinders when an anti-lock braking system of the vehicle is performing a pressure-reducing operation.

11. The brake control apparatus as claimed in claim 9, wherein:
each pressure-increasing control valve is a normally open electromagnetic valve;
each pressure-increasing control valve includes a valve element arranged to close in a direction against application of pressure of the master cylinder; and
each pressure-increasing control valve is applied with at least an electric current that allows the pressure-increasing control valve to be maintained in closed state when the pressure of the master cylinder is equal to a predetermined value.

12. The brake control apparatus as claimed in claim 9, further comprising a braking operation detecting section configured to detect driver's braking operation, wherein the hydraulic pressure control section is configured to implement the control operation by:
controlling at least one of the pressure-increasing control valves toward closed state, and controlling at least one of the pressure-increasing control valves toward open state except the at least one of the pressure-increasing control valves being controlled toward closed state, in response to detection of driver's braking operation by the braking operation detecting section; and
thereafter controlling toward open state at least one of the pressure-reducing control valves corresponding to at least one of the pressure-increasing control valves being controlled toward open state.

13. The brake control apparatus as claimed in claim 9, further comprising a pump configured to suck brake fluid stored in the reservoir, and raise the hydraulic pressure of the wheel cylinders, wherein the hydraulic pressure control section is configured to close the pressure-reducing control valves, and control the pressure-increasing control valves toward open state, with the pump being driven.

14. The brake control apparatus as claimed in claim 9, wherein the one of the pressure-increasing control valves being controlled toward closed state corresponds to the wheel cylinder of a front road wheel of the vehicle.

15. A brake control apparatus for a vehicle, wherein: the vehicle includes: a hydraulic braking system configured to generate a first braking force by controlling hydraulic pressure of brake fluid in each of wheel cylinders, wherein each wheel cylinder is provided at a corresponding one of road wheels; and a second braking system configured to generate a second braking force; and the vehicle is configured to be braked by the first braking force generated by the hydraulic braking system and the second braking force generated by the second braking system; and wherein the brake control apparatus comprises:
a braking operation detecting section configured to detect driver's braking operation;
pressure-increasing control valves each of which is disposed between a master cylinder and a corresponding one of the wheel cylinders;
a reservoir into which brake fluid flows from the wheel cylinders when an anti-lock braking system of the vehicle is performing a pressure-reducing operation;
pressure-reducing control valves each of which is disposed between the reservoir and a corresponding one of the wheel cylinders; and
a hydraulic pressure control section configured to perform a control operation in response to detection of driver's braking operation by the braking operation detecting section, wherein the control operation includes:
controlling at least one of the pressure-increasing control valves toward closed state;
controlling at least one of the pressure-increasing control valves toward open state except the at least one of the pressure-increasing control valves being controlled toward closed state;
controlling toward open state at least one of the pressure-reducing control valves corresponding to at least one of the pressure-increasing control valves being controlled toward open state;
allowing fluid communication between the master cylinder and the reservoir; and
preventing fluid communication between the master cylinder and at least one of the wheel cylinders.

16. The brake control apparatus as claimed in claim 15, wherein the second braking system is a regenerative braking system configured to generate the second braking force electrically at the road wheels.

17. The brake control apparatus as claimed in claim 15, wherein the one of the pressure-increasing control valves being controlled toward closed state corresponds to the wheel cylinder of a front road wheel of the vehicle.

18. The brake control apparatus as claimed in claim 15, wherein:
the wheel cylinders are provided at left and right front road wheels and left and right rear road wheels of the vehicle, respectively;
at least two of the wheel cylinders constitute a hydraulic line section; and
the hydraulic line section includes the one of the pressure-increasing control valves being controlled toward closed state during the control operation, and includes the one of the pressure-reducing control valves controlled toward open state during the control operation.

19. The brake control apparatus as claimed in claim 18, wherein:
the reservoir is configured to store a quantity of brake fluid that is flown out of the master cylinder, by fluid communication between the master cylinder and the reservoir;
the brake control apparatus further comprises a pump configured to suck brake fluid stored in the reservoir, and raise the hydraulic pressure of the wheel cylinders; and
the hydraulic pressure control section is configured to close the pressure-reducing control valves, and control the pressure-increasing control valves toward open state, with the pump being driven.

20. The brake control apparatus as claimed in claim 18, wherein:
each pressure-increasing control valve is a normally open electromagnetic valve;
each pressure-increasing control valve includes a valve element arranged to close in a direction against application of pressure of the master cylinder; and
each pressure-increasing control valve is applied with at least an electric current that allows the pressure-increasing control valve to be maintained in closed state when the pressure of the master cylinder is equal to a predetermined value.
